(19) United States
(12) Patent Application Publication
(10) Pub. No.: US 2011/0227905 A1
(43) Pub. Date: Sep. 22, 2011

(54) DRIVER AND DISPLAY DEVICE USING THE SAME

(75) Inventor: Hiroyasu ENJOU, Kanagawa (JP)

(73) Assignee: RENESAS ELECTRONICS CORPORATION

(21) Appl. No.: 13/048,505

(22) Filed: Mar. 15, 2011

(30) Foreign Application Priority Data
Mar. 18, 2010 (JP) 2010-062055

(51) Int. Cl. G09G 5/00

(52) U.S. Cl. 345/212

(57) ABSTRACT

A driver includes a digital-to-analog converter configured to perform digital-to-analog conversion on digital gray scale data to output an analog output gray scale voltage; an output amplifier section having a first input connected with an output of the digital-to-analog converter, and an output connected with an output node, and a second input connected with the output of the output amplifier section through a negative feedback wiring, and configured to output the output gray scale voltage to the output node in response to a control signal in an operation mode. A test switch is connected between the first input and the second input in the output amplifier section and is configured to output the output gray scale voltage to the output node in response to a test signal in a test mode for a test of an output of the digital-to-analog converter.

### CROSS REFERENCE

This patent application claims a priority on convention based on Japanese Patent Application No. 2010-62055 filed on Mar. 18, 2010. The disclosure thereof is incorporated herein by reference.

### BACKGROUND

The present invention relates to a driver or a data driver and a display apparatus such as a TFT (Thin Film Transistor) type liquid crystal display apparatus.

A TFT (Thin Film Transistor) type liquid crystal display apparatus is popularized. The display apparatus is provided with a display panel such as an LCD (Liquid Crystal Display) panel, a gate driver, a plurality of data drivers. In the display panel, a plurality of gate lines are connected to the gate driver, and a plurality of data lines connected to the plurality of data drivers. Each of the plurality of gate lines is connected to gate electrodes of TFTs of pixels of a row. Each of the plurality of data lines is connected to drain electrodes of the TFTs of the pixels of a column.

Each of the data drivers is provided with a shift register, a data register, a data latch circuit, a level shifter circuit, a digital/analogue (D/A) converter, an output amplifier circuit, and a plurality of output nodes. The plurality of output nodes are respectively connected to the plurality of data lines.

The shift register shifts a shift signal in synchronization with a clock signal, and outputs the shifted signal to the data register. The data register receives gray scale data for one horizontal line in synchronization with the shifted signal from the shift register, and outputs the gray scale data to the data latch circuit. The data latch circuit latches the gray scale data for one horizontal line at a same timing, and outputs the gray scale data to the level shifter circuit. The level shifter circuit converts the signal levels of the gray scale data for one horizontal line from the data latch circuit, to output to the D/A converter.

The D/A converter circuit performs D/A conversion on the gray scale data for one horizontal line from the level shifter circuit, and outputs output gray scale voltages for one horizontal line as an analog signals to the output amplifier circuit. The D/A converter circuit is provided with a gray scale voltage generating circuit, and a plurality of D/A converters (hereinafter, to be referred to as the “DACs”).

The gray scale voltage generating circuit is provided with gray scale resistances connected in series. This gray scale voltage generating circuit divides a reference voltage supplied from a power supply circuit by the gray scale resistances to generate a plurality of gray scale voltages.

The plurality of DACs select the output gray scale voltages in response to the gray scale data for one horizontal line from among the gray scale voltages generated in the gray scale voltage generating circuit, and outputs the plurality of output gray scale voltages to the output amplifier circuit.

The output amplifier circuit is provided with a plurality of output amplifier sections. The outputs of the plurality of output amplifier sections are connected to the plurality of data lines through the plurality of output nodes. The plurality of output amplifier sections amplify and output the plurality of output gray scale voltages to the plurality of data lines.

As described above, the data driver is provided with a large number of DACs for driving the pixels for one horizontal line. Therefore, a test circuit for testing that the large number of DACs normally operates is highly complicated. Thus, it is desired to test the output voltages outputted from the DACs and leakage currents for as a short time as possible, over a wide range including each output and each gray scale.

Since a price of a liquid crystal display apparatus abruptly reduces, lowering of the price of the data driver used in the display apparatus is strongly desired. Thus, a driver LSI (Large-Scale Integrated circuit) with high quality, low cost and a saved area is strongly desired.

FIG. 1 shows connection from a DAC to an output node in a conventional data driver described in JP 2007-65538A. The data driver is further provided with a plurality of test switches 141 and a plurality of output switches 142.

An output amplifier section 140 (the output amplifier section 140 is described as “AMP 140” in FIG. 1) is connected between a DAC 150 serving as the above DAC and an output node OUT. Specifically, a first input of the output amplifier section 140 is connected to an output of the DAC 150, and an output of the output amplifier section 140 is connected to the output node OUT. A second input and the output of the output amplifier section 140 are connected to each other through a negative feedback wiring 143.

The first input of the output amplifier section 140 and the output node OUT are connected to each other by a test wiring 144.

The test switch 141 is provided on the test wiring 144, and realized by a transistor. The test switch 141 is turned on in response to a test signal TEST.

The output switch 142 is connected between the output of the output amplifier section 140 and the output node OUT, and realized by a transistor. The output switch 142 is turned off in response to a first output control signal and turned on in response to a second output control signal.

The data driver executes an operation mode and a test mode in which a test relating to an output of the DAC 150 is performed.

The operation mode includes an initial mode and a stable mode after the initial mode. The initial mode indicates a mode in a period before the output of the gray scale voltage generating circuit is stabilized, and the stable mode indicates a mode in a period after the output of the gray scale voltage generating circuit is stabilized. In the initial mode, the first output control signal is supplied to the output switch 142, and in the stable mode, the second output control signal is supplied to the output switch 142.

In the initial mode, the output switch 142 is turned off in response to the first output control signal, so that an output of the output amplifier section 140 have high impedance until the output of the gray scale voltage generating circuit is stabilized.

In the stable mode, the output switch 142 is turned on in response to the second control signal. In this case, the output amplifier section 140 outputs an output gray scale voltage from the DAC 150 to the output node OUT through the output switch 142.

In the test mode, the test signal TEST is supplied to the test switch 141, and the first output control signal is supplied to the output switch 142. In this case, the test switch 141 is turned on in response to the test signal TEST, and the output switch 142 is turned off in response to the first output control signal. At this time, the output of the DAC 150 is connected or bypassed to the output node OUT through the test switch 141 and the test wiring 144. Therefore, the output gray scale voltage from the DAC 150 is outputted to the output node OUT through the test switch 141 and the test wiring 144.

Thereby, the output voltage outputted from the DAC and leakage current can be measured.

### CITATION LIST

[Patent Literature]: JP 2007-65538A

### SUMMARY OF THE INVENTION

In the conventional data driver, there is a need for providing the test wiring 144 separately from the negative feedback wiring 143. The test wiring 144 is laid out around the output amplifier section 140. The output amplifier section 140 generally includes transistors. In this case, due to parasitic capacity of the test wiring 144 and a change in an interface state caused by the test wiring 144 laid around the output amplifier section 140, characteristics of the transistor are influenced, and there is a possibility that a characteristic such as a deviation of the output amplifier section 140 is degraded.

In the conventional data driver, since the test wiring 144 is provided separately from the negative feedback wiring 143, a layout area is increased. That is, chip size is increased. Further, in the conventional data driver, in order to avoid degradation of the characteristics of the output amplifier section 140, the output amplifier section 140 and the test wiring 144 may be laid out while providing a predetermined space therebetween. However, in this case, the chip size is also increased.

In an aspect of the present invention, a driver includes: a digital-to-analog converter configured to perform digital-to-analog conversion on digital gray scale data to output an analog output gray scale voltage; an output amplifier section having a first input connected with an output of the digital-to-analog converter, an output connected with an output node, and a second input connected with the output of the output amplifier section through a negative feedback wiring, and configured to output the output gray scale voltage to the output node in response to a control signal in an operation mode; and a test switch connected between the first input and the second input in the output amplifier section and configured to output the output gray scale voltage to the output node in response to a test signal in a test mode for a test of an output of the digital-to-analog converter.

In another aspect of the present invention, a display apparatus includes a display panel; and a driver connected with the display section through an output node. The driver includes a digital-to-analog converter configured to perform digital-to-analog conversion on digital gray scale data to output an analog output gray scale voltage; an output amplifier section having a first input connected with an output of the digital-to-analog converter, an output connected with an output node, and a second input connected with the output of the output amplifier section through a negative feedback wiring, and configured to output the output gray scale voltage to the output node in response to a control signal in an operation mode; and a test switch connected between the first input and the second input in the output amplifier section and configured to output the output gray scale voltage to the output node in response to a test signal in a test mode for a test of an output of the digital-to-analog converter.

In still another aspect of the present invention, a test method of an output of a digital-to-analog converter, is achieved by performing digital-to-analog conversion on digital gray scale data to output an analog output gray scale voltage; by amplifying the output gray scale voltage by an output amplifier section to output an output node in response to a control signal in an operation mode; by inactivating the output amplifier section in a test mode; and by outputting the output gray scale voltage to the output node by turning on a switch in response to a test signal in the test mode, wherein the switch is provided between a first input and a second input in the output amplifier section, and the second input is connected to the output of the output amplifier section.

As described above, in the present invention, a test switch is provided between a first input and a second input of an output amplifier section, and in a test mode, by turning on the test switch and bypassing an output of a D/A converter to an output node (OUT) through the test switch and the negative feedback wiring, an output voltage outputted from the D/A converter and the leakage current can be measured. Thus, there is no need for providing a new wiring for bypass as the test wiring 144.

In such a way, according to the present invention, since there is no need for the test wiring, the characteristic degradation such as deviation of an output amplifier section can be avoided.

According to the present invention, since there is no need for the test wiring, a layout area is not accordingly increased. That is, an increase in chip size can be suppressed.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 shows connection from a DAC to an output node in a conventional data driver;

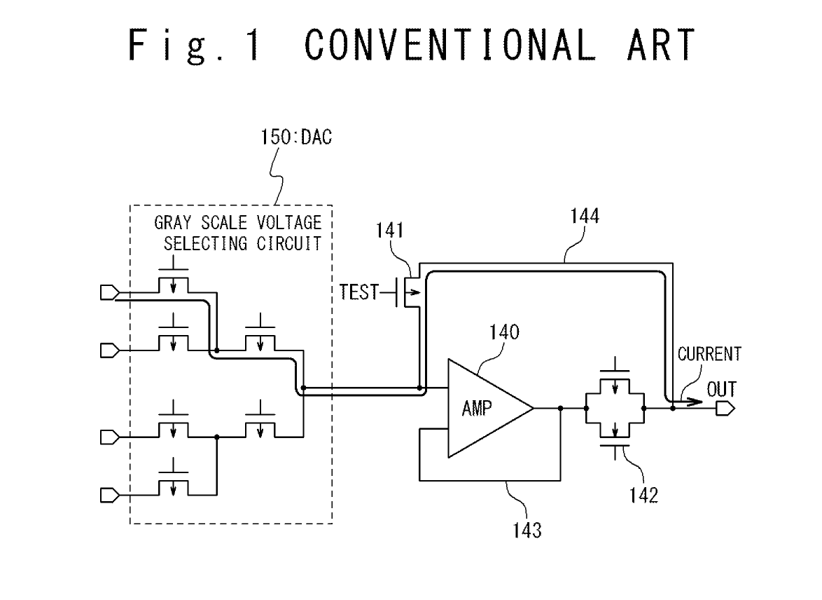

FIG. 2 shows a configuration of a display apparatus according to an embodiment of the present invention;

FIG. 3 shows a configuration of the data driver;

FIG. 4 shows connection from a DAC to an output node; and

FIG. 5 is a timing chart showing operation of the data driver 30.

### DETAILED DESCRIPTION

Hereinafter, a display apparatus such as a TFT (Thin Film Transistor) type liquid crystal display apparatus using a driver such as a data driver according to the present invention will be described below in detail with reference to the attached drawings.

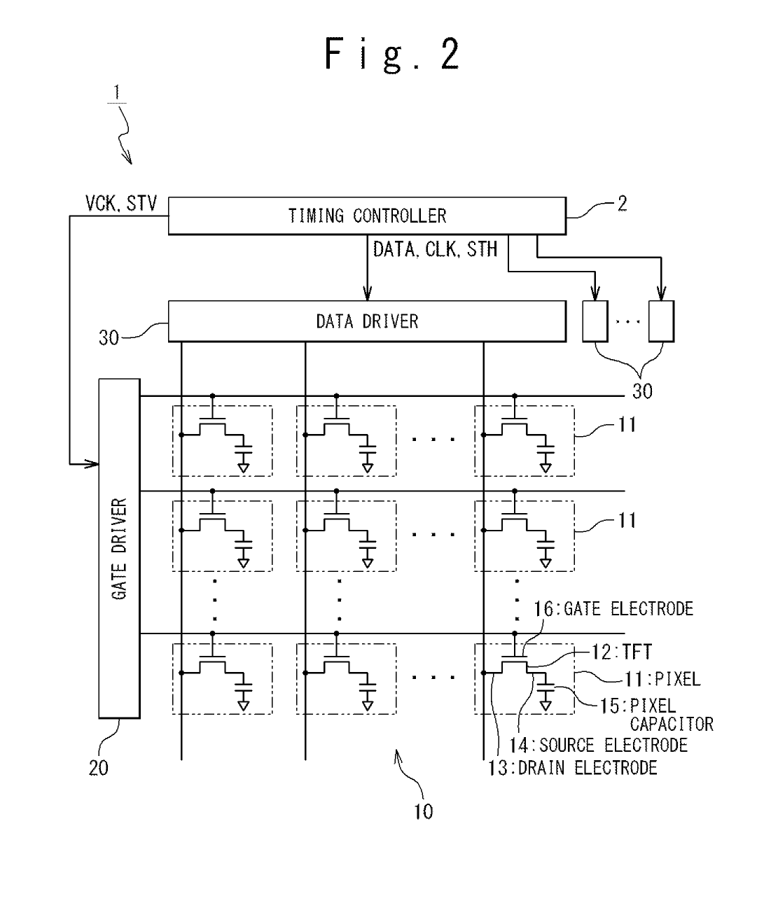

FIG. 2 shows a configuration of the display apparatus 1 according to an embodiment of the present invention. Referring to FIG. 2, the display apparatus 1 according to the embodiment of the present invention is provided with a display panel 10. The display panel 10 is provided with a plurality of pixels 11 arranged in a matrix. Each of the plurality of pixels 11 is provided with a thin film transistor (TFT) 12. The pixel 11 is further provided with a pixel capacitor 15 in a case of the liquid crystal display panel. The pixel capacitor 15 is provided with a pixel electrode, and a counter electrode opposing to the pixel electrode. The TFT 12 has a drain electrode 13, a source electrode 14 connected to the pixel electrode, and a gate electrode 16.

The display apparatus 1 according to the embodiment of the present invention is further provided with a gate driver 20 to driving the plurality of pixels 11 of the display panel 10, and a plurality of data drivers 30.

The display panel 10 is further provided with a plurality of gate lines connected to the gate driver 20, and a plurality of data lines connected to the plurality of data drivers 30. The plurality of gate lines are connected to the gate electrodes 16 of the TFTs 12 of rows of the pixels 11. The plurality of data lines are connected to the drain electrodes 13 of the TFTs 12 of columns of the pixels 11.

The display apparatus 1 is further provided with a timing controller 2.

The timing controller 2 outputs a vertical clock signal VCK and a vertical shift signal STV in one horizontal period to the gate driver 20. The gate driver 20 selects one next to the current gate line from among the plurality of gate lines in response to the vertical shift signal STV and the vertical clock signal VCK. At this time, a horizontal selection signal is outputted to the selected gate line, so that the TFTs 12 of the pixels 11 connected with the selected gate line are turned on.

The timing controller 2 outputs digital gray scale data DATA, a clock signal CLK, and a horizontal shift signal STH to the data drivers 30. The gray scale data DATA specifies gray scale levels of the plurality of pixels for the one line. The data drivers 30 output the gray scale data DATA to the plurality of data lines in response to the horizontal shift signal STH and the clock signal CLK. At this time, the TFTs 12 of the pixels 11 connected to the selected gate line and the plurality of data lines are activated. Therefore, the gray scale data DATA are respectively written to the pixel capacitors 15 of the above pixels 11 and held until next gray scale data is written. Thereby, the gray scale data DATA are displayed.

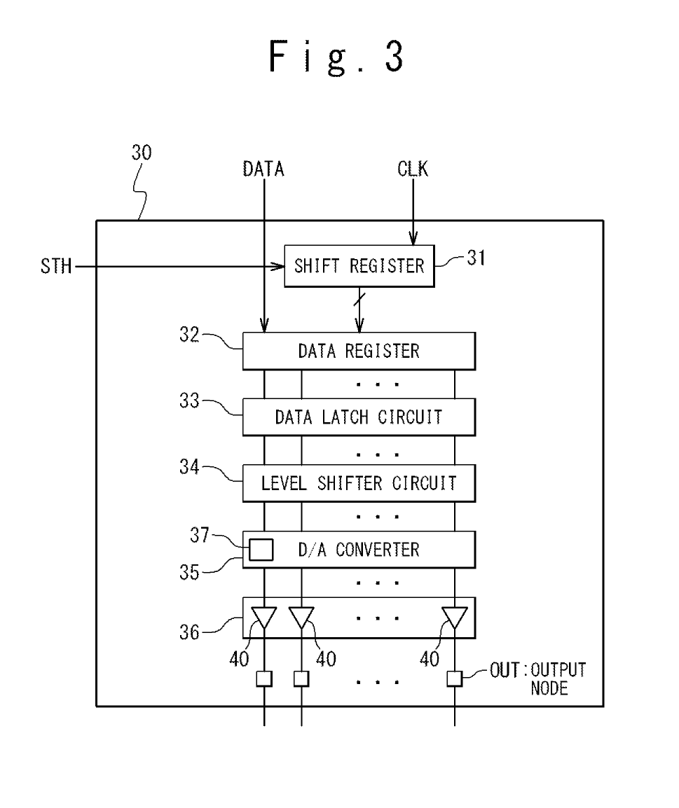

FIG. 3 shows a configuration of each of the data drivers 30. The data driver 30 is provided with a shift register 31, a data register 32, a data latch circuit 33, a level shifter 34, a digital-to-analog (D/A) converter 35, an output amplifier circuit 36, and a plurality of output nodes OUT. The plurality of output nodes OUT are respectively connected to the plurality of data lines.

The shift register 31 shifts the horizontal shift signal STH in synchronization with the clock signal CLK, and outputs the shifted signal STH to the data register 32. The data register 32 receives the gray scale data DATA from the timing controller 2 in response to the shifted signal STH from the shift register 31, and outputs the gray scale data to the data latch circuit 33.

The data latch circuit 33 latches the gray scale data DATA at the same timing, and outputs the gray scale data to the level shifter circuit 34.

The level shifter circuit 34 converts levels of the gray scale data DATA from the data latch circuit 33 to conversion levels in a predetermined maximum level, and outputs the gray scale data DATA having the conversion levels to the D/A converter 35.

The D/A converter circuit 35 performs D/A conversion to the gray scale data DATA from the level shifter circuit 34, and outputs analog output gray scale voltages for the selected gate line to the output amplifier circuit 36.

The D/A converter circuit 35 is provided with a gray scale voltage generating circuit 37, and a plurality of D/A converters (hereinafter, to be referred to as the “DACs”).

The gray scale voltage generating circuit 37 is provided with gray scale resistances connected in series. The gray scale voltage generation circuit 37 divides a reference voltage supplied from a power supply circuit (not shown) by the gray scale resistances to generate a plurality of gray scale voltages.

The plurality of DACs selects the output gray scale voltages corresponding to the gray scale data DATA from among the gray scale voltages generated in the gray scale voltage generation circuit 37, and outputs the selected output gray scale voltages to the output amplifier circuit 36.

The output amplifier circuit 36 is provided with a plurality of output amplifier sections 40. Outputs of the output amplifier sections 40 are respectively connected to the plurality of data lines through the plurality of output nodes OUT. The output amplifier section 40 operates in accordance with a control signal. The plurality of output amplifier sections 40 amplify and output the selected output gray scale voltages to the data lines based on the control signal.

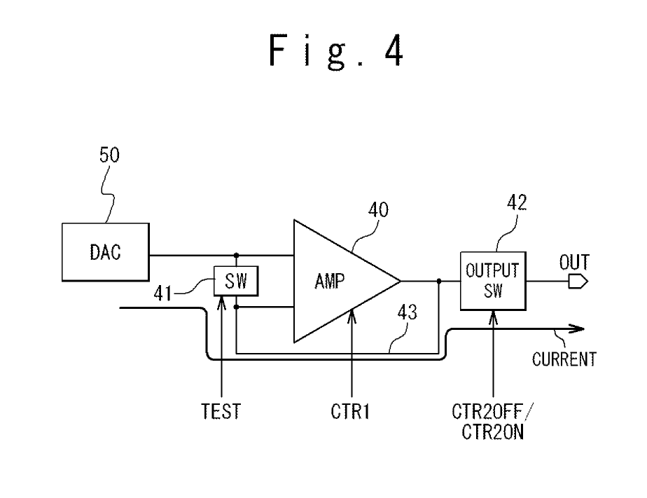

FIG. 4 shows connection from the DAC to the output node. The data driver 30 is further provided with a plurality of test switches SW 41, and a plurality of output switches SW 42.

The output amplifier section AMP 40 is connected between the digital-to-analog converter DAC 50 and the output node OUT. Specifically, a first input of the output amplifier section AMP 40 is connected to an output of the DAC 50, and an output of the output amplifier section AMP 40 is connected to the output node OUT. A second input and the output of the output amplifier section 40 are connected to each other through a negative feedback loop 43. The output amplifier section AMP 40 outputs the output gray scale voltage to the output node OUT in response to the control signal CTR1.

The test switch SW 41 is connected between the first input and the second input of the output amplifier section AMP 40, and realized by a single or a plurality of transistors. The test switch SW 41 is turned ON in accordance with a test signal TEST.

The output switch SW 42 is connected between the output of the output amplifier section AMP 40 and the output node OUT, and realized by a single or a plurality of transistors. The output switch SW 42 is turned on in response to the control signal CTR2. The control signal CTR2 when the switch SW 42 is turned on is referred to as a signal CTR2ON, and the control signal CTR2 when the switch SW 42 is turned off is referred to as a signal CTR2OFF.

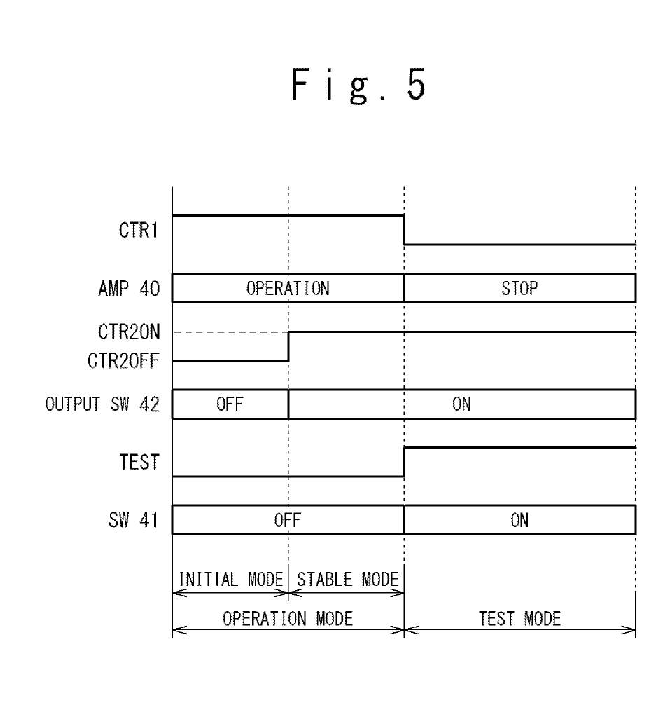

FIG. 5 shows timing charts in the operation of the data driver 30. The data driver 30 executes an operation mode and a test mode, in which a test related to an output of the DAC 50 is performed. The test includes measurement of output voltage outputted from the DAC 50 in the gray scale voltage generating circuit 37 and leakage current.

In the operation mode, the control signal CTR1 is supplied to the output amplifier section AMP 40. In this case, the output amplifier section AMP 40 operates in response to the control signal CTR1.

The operation mode includes an initial mode and a stable mode after the initial mode. The initial mode indicates a mode in a period before the output of the gray scale voltage generating circuit 37 is stabilized, and the stable mode indicates a mode in a period after the output of the gray scale voltage generating circuit 37 is stabilized. In the initial mode, the control signal CTR2OFF is supplied to the output switch SW 42, and in the stable mode, the control signal CTR2ON is supplied to the output switch SW 42.

In the initial mode, the output switch SW 42 is turned off in response to the control signal CTR2OFF, so that the output of the output amplifier section AMP 40 is not connected with the output node OUT until the output of the gray scale voltage generating circuit 37 is stabilized.

In the stable mode, the output switch SW 42 is turned on in response to the control signal CTR2ON. In this case, the output amplifier section AMP 40 outputs the output gray scale voltage from the DAC 50 to the output node OUT through the output switch SW 42 in response to the control signal CTR1.

The supply of the control signal CTR1 is stopped in the test mode to stop the operation of the output amplifier section AMP 40. The test signal TEST is supplied to the test switch SW 41, and the control signal CTR2ON is supplied to the output switch SW 42. In this case, the test switch SW 41 is turned on in response to the test signal TEST, and the output switch SW 42 is turned on in response to the control signal CTR2ON. At this time, the output of the DAC 50 is connected (bypassed) to the output node OUT through the test switch SW 41, the negative feedback loop 43, and the output switch SW 42. Therefore, the output gray scale voltage from the DAC 50 is outputted to the output node OUT through the test switch SW 41, the negative feedback loop 43, and the output switch SW 42.

Thereby, the output voltage outputted from the DAC 50 in the gray scale voltage generating circuit 37 and the leakage current can be measured.

As described above, in the display apparatus 1 according to the embodiment of the present invention, the test switch SW 41 is provided between the first input and the second input of the output amplifier section AMP 40, In the test mode, by turning on the test switch 41 and bypassing the output of the DAC 50 to the output node OUT through the test switch SW 41, the negative feedback loop 43, and the output switch SW 42, the output voltage outputted from the DAC 50 and the leakage current can be measured. Thus, there is no need for providing a new wiring for bypass such as the test wiring 144 in the conventional example.

As such, with the display apparatus 1 according to the embodiment of the present invention, since the test wiring 144 is not required, a degradation of characteristics such as deviation of the output amplifier section can be avoided.

With the display apparatus 1 according to the embodiment of the present invention, since the test wiring 144 is not required, a layout area is not accordingly increased. That is, an increase in chip size can be suppressed.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A driver comprising:
a digital-to-analog converter configured to perform digital-to-analog conversion on digital gray scale data to output an analog output gray scale voltage;
an output amplifier section having a first input connected with an output of said digital-to-analog converter, an output connected with an output node, and a second input connected with the output of said output amplifier section through a negative feedback wiring, and configured to output the output gray scale voltage to said output node in response to a control signal in an operation mode; and
a test switch connected between said first input and said second input in said output amplifier section and configured to output the output gray scale voltage to said output node in response to a test signal in a test mode for a test of an output of said digital-to-analog converter.

2. The driver according to claim 1, wherein the operation mode comprises an initial mode and a stable mode after the initial mode,
wherein said driver further comprises:
an output switch connected between the output of said output amplifier section and said output node, wherein said output switch is turned off in response to a first output control signal in the initial mode, and turned on in response to a second output control signal in the stable mode and the test mode.

3. The driver according to claim 2, further comprising:
a gray scale voltage generating circuit configured to generate a plurality of gray scale voltages by dividing a reference voltage by using resistances,
wherein said digital-to-analog converter selects the output gray scale voltage from among the plurality of gray scale voltages based on gray scale data and outputs the selected output gray scale data to said output amplifier section,
wherein the initial mode indicates a mode in a period until an output of said gray scale voltage generating circuit is stable, and the stable mode indicates a mode in a period after the output of said gray scale voltage generating circuit is stabilized, and
wherein said output switch is turned off in the initial mode.

4. A display apparatus comprising:
a display panel; and
a driver connected with said display section through an output node,
wherein said driver comprises:
a digital-to-analog converter configured to perform digital-to-analog conversion on digital gray scale data to output an analog output gray scale voltage;
an output amplifier section having a first input connected with an output of said digital-to-analog converter, an output connected with an output node, and a second input connected with the output of said output amplifier section through a negative feedback wiring, and configured to output the output gray scale voltage to said output node in response to a control signal in an operation mode; and
a test switch connected between said first input and said second input in said output amplifier section and configured to output the output gray scale voltage to said output node in response to a test signal in a test mode for a test of an output of said digital-to-analog converter.

5. The display apparatus according to claim 4, wherein the operation mode comprises an initial mode and a stable mode after the initial mode,
wherein said driver further comprises:
an output switch connected between the output of said output amplifier section and said output node, wherein said output switch is turned off in response to a first output control signal in the initial mode, and turned on in response to a second output control signal in the stable mode and the test mode.

6. The display apparatus according to claim 5, wherein said driver further comprises:
a gray scale voltage generating circuit configured to generate a plurality of gray scale voltages by dividing a reference voltage by using resistances,
wherein said digital-to-analog converter selects the output gray scale voltage from among the plurality of gray scale voltages based on gray scale data and outputs the selected output gray scale data to said output amplifier section,
wherein the initial mode indicates a mode in a period until an output of said gray scale voltage generating circuit is stable, and the stable mode indicates a mode in a period after the output of said gray scale voltage generating circuit is stabilized, and
wherein said output switch is turned off in the initial mode.

7. A test method of an output of a digital-to-analog converter, comprising:
performing digital-to-analog conversion on digital gray scale data to output an analog output gray scale voltage;
amplifying the output gray scale voltage by an output amplifier section to output an output node in response to a control signal in an operation mode;
inactivating said output amplifier section in a test mode; and
outputting the output gray scale voltage to said output node by turning on a switch in response to a test signal in the test mode, wherein said switch is provided between a first input and a second input in said output amplifier section, and said second input is connected to the output of said output amplifier section.

8. The test method according to claim 7, wherein the operation mode comprises an initial mode and a stable mode after the initial mode,
wherein said test method further comprises:
turning off an output switch connected between the output of said output amplifier section and said output node, is turned off in response to a first output control signal in the initial mode; and
turning on said output switch in response to a second output control signal in the stable mode and the test mode.

9. The test method according to claim 8, further comprising:
generating a plurality of gray scale voltages by dividing a reference voltage by resistances; and
selecting the output gray scale voltage from among the plurality of gray scale voltages based on gray scale data to output to said output amplifier section.
